(19) United States
(12) Patent Application Publication
(10) Pub. No.: US 2007/0278327 A1
(43) Pub. Date: Dec. 6, 2007

(54) Fluids mixing nozzle

(75) Inventor: Joseph E. Wolfe, Richboro, PA (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(73) Assignee: The United States of America as represented by the Secretary of the Navy

(21) Appl. No.: 11/449,179

(22) Filed: Jun. 5, 2006

(51) Int. Cl. B05B 7/04; B05B 7/12; B05B 7/06

(52) U.S. Cl. 239/398; 239/417.5; 239/424.5

(57) ABSTRACT

The fluids mixing nozzle includes a mixing chamber, a first fluid supply port, a second fluid supply port, a nozzle port and a converging-diverging nozzle. The mixing chamber includes a first side and a second side. The first fluid supply port flowably communicates with the mixing chamber. The second fluid supply port flowably communicates with the mixing chamber. The first fluid supply port and the second fluid supply port are disposed on the first side of the mixing chamber. The nozzle port is disposed on the second side of the mixing chamber and allows fluid communication between the mixing chamber and the converging-diverging nozzle. The converging-diverging nozzle includes a nozzle intake section, a convergent mixing flow zone, a throat section, a divergent mixing flow zone and a nozzle exit section.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a mixing nozzle for mixing or atomizing fluids (liquids or gases) and/or substances. More specifically, but without limitation, the present invention relates to a mixing nozzle for mixing or atomizing fluids and/or substances, with the nozzle having a preliminary mixing chamber and a converging-diverging nozzle for primary mixing, the nozzle capable of being connected with two or more sources of fluids and/or substances.

Fluorocarbon-based and halon fire extinguishants are environmentally harmful since they cause depletion of the earth's ozone layer. Present U.S. law and the 1988 Montreal Protocol requires the phase out and replacement of such materials. The 1988 Montreal Protocol classified halon as a Class I Ozone Depleting Substance (ODS), and called for limits on global production by over 100 developed nation signatories. Furthermore, the U.S. Clean Air Act Amendments of 1990 called for the ban on production of halons in the U.S after January 1994. This law also prohibits purposeful venting and required personnel training involving halon use, so as to minimize the emission thereof into the atmosphere.

The U.S. Navy has responded to the requirements of these Acts by prohibiting the use of ODSs in new government procurement contracts, and is attempting to find and use alternative designs in fire extinguishment systems. Therefore, a need exists to replace all halon systems and to improve existing water sprinkler based systems for more effective fire extinguishment use.

As an alternative to halon systems, fine water mist (FWM) type systems are used, which have very favorable characteristics as replacements for existing halon systems and have been studied and researched by Naval scientists. Typically, such FWM systems include nozzles for creating misting fluids using a pressurized gas, and are well-known. Specifically, in such FWM systems, a liquid is directed into a central bore of a nozzle, which directs a high-velocity gas, so as to create a mist of the liquid. In some nozzles, the velocity and pressure of the gas are increased in a narrowed throat area of the bore, which causes the atomization of the fluid into small droplets as the gas travels through the nozzle.

In FWM systems, to aid atomization and provide an unobstructed flow path for the gas, the fluid is usually injected into the gas stream through an aperture in the bore wall so that two different fluid streams impinge at a 90-degree angle. Nozzles of the above-described FWM type systems require high-pressure spraying of the liquid and the gas, which is undesirable, as it is inconvenient, expensive to manufacture and difficult to maintain. For example, with such FWM mixing nozzles, the liquid and gas must be sprayed through fine holes of a small diameter, with the fine holes easily clogging or wearing away.

The use of water for a spray for fire extinguishment is well-known. Liquid-only, water spray nozzles for fire extinguishment create water droplets by deflecting the water flow just ahead of the spouting aperture. The droplets' size are relatively large, and a desirable fine water mist cannot be achieved.

Thus, there is a need for a low-pressure, reliable liquid/gas mixing nozzle and one which is effective for fire extinguishment as disclosed in U.S. Pat. No. 5,520,331 entitled “Liquid Atomizing Nozzle.” U.S. Pat. No. 5,520,331 has the same inventor and assignee as the present invention and is herein incorporated by reference.

### SUMMARY

It is a feature of the invention to provide a fluids mixing nozzle for mixing and atomization of fluids and/or substances. The fluids mixing nozzle includes a mixing chamber, a first fluid supply port, a second fluid supply port, a nozzle port and a converging-diverging nozzle. The mixing chamber includes a first side and a second side, the first side and the second side are disposed on opposite sides of the mixing chamber. The first fluid supply port flowably communicates with the mixing chamber, and the first fluid supply port is disposed on the first side of the mixing chamber. The second fluid supply port flowably communicates with the mixing chamber, and the second fluid supply port is disposed on the first side of the mixing chamber. The nozzle port is disposed on the second side of the mixing chamber and allows fluid communication between the mixing chamber and the converging-diverging nozzle. The converging-diverging nozzle includes a nozzle intake section, a convergent mixing flow zone adjacent to the nozzle intake section, a throat section adjacent to the convergent mixing flow zone, a divergent mixing flow zone adjacent to the throat section, and a nozzle exit section adjacent to the divergent mixing flow zone. The throat section has an inner diameter smaller than the inner diameter of the nozzle intake section.

It is feature of the present invention to provide a fluids mixing nozzle capable of creating an extremely fine, liquid atomization with low pressurization of the fluid or substance being delivered to the nozzle. Furthermore, it is a feature of the present invention to provide a fluids mixing nozzle capable of delivering an atomized fluid and/or substance through relatively large apertures so that wear and clogging of the nozzle are minimized.

It is a feature of the invention to provide a fluids mixing nozzle for the mixing and atomization of fluids (and/or substances), which enables fluids to be atomized at low pressure, while also providing a reliable, low maintenance design.

It is also a feature of the invention to provide a fluids mixing nozzle that is a non-clogging nozzle for mixing two or more fluids and/or substances.

It is also a feature of the invention to provide a fluids mixing nozzle that provides an effective means to mix and deliver a resultant mixture at low pressure.

It is also a feature of the invention to provide a fluids mixing nozzle that is capable of mixing and atomizing fluids at low pressures (typically from 2-20 psi).

It is also a feature of the invention to provide a means for more than one fluids mixing nozzle that is capable of mixing and atomizing fluids or substances at low pressure.

### DRAWINGS

These and other features, aspects and advantages of the present invention will become better understood with reference to the following description and appended claims, and accompanying drawings wherein:

FIG. 1 is a cross-sectional view of an embodiment of the fluids mixing nozzle;

FIG. 2 is a perspective view of an embodiment of the fluids mixing nozzle; and

FIG. 3 is a flow chart illustrating the steps taken in the atomizing of fluid using the fluids mixing nozzle, while utilizing multiple converging-diverging nozzles.

### DESCRIPTION

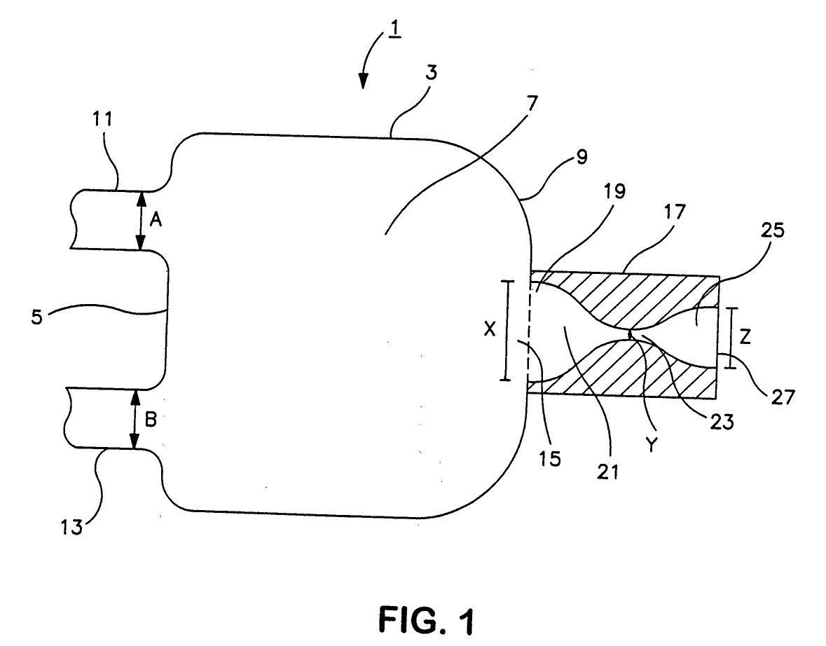

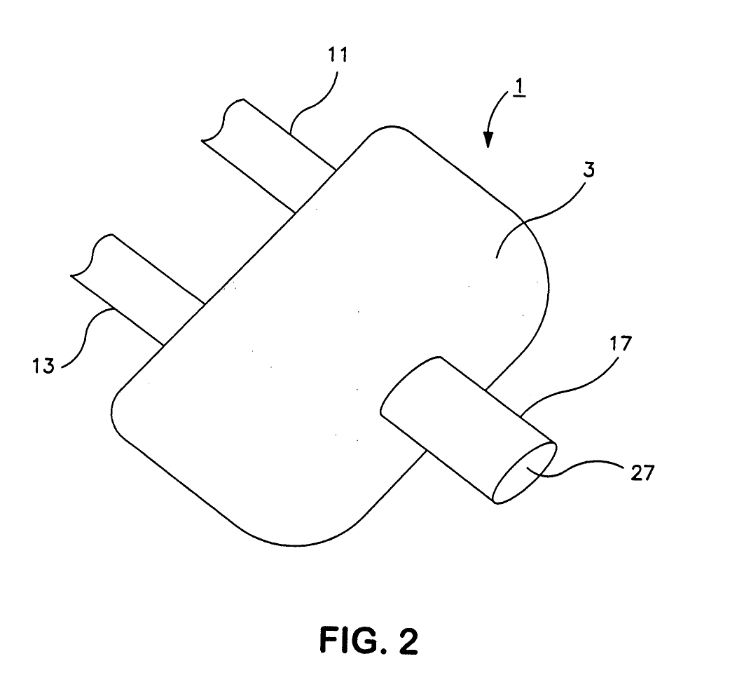

The preferred embodiment of the present invention is illustrated by way of example below and in FIGS. 1-3. As shown in FIG. 1, the fluids mixing nozzle 1 includes a mixing chamber 3, a first fluid supply port 11, a second fluid supply port 13, a nozzle port 15 and a converging-diverging nozzle 17. The mixing chamber 3 includes a first side 5 and a second side 9, the first side 5 and the second side 9 are disposed on opposite sides of the mixing chamber 3. The first fluid supply port 11 flowably communicates with the mixing chamber 3 (specifically the internal portion 7 of the mixing chamber 3), and the first fluid supply port 11 is disposed on the first side 5 of the mixing chamber 3. The second fluid supply port 13 flowably communicates with the mixing chamber 3 (specifically the internal portion 7 of the mixing chamber 3), and the second fluid supply port 13 is disposed on the first side 5 of the mixing chamber 3. The nozzle port 15 is disposed on the second side 9 of the mixing chamber 3 and allows fluid communication between the mixing chamber 3 (specifically the internal portion 7 of the mixing chamber 3) and the converging-diverging nozzle 17.

In the discussion of the present invention, the invention will be discussed in a fire extinguishing environment; however, this invention can be utilized for any type of need that requires use of a fluids mixing nozzle. For instance, but without limitation, the fluids mixing nozzle may be used for: portable fire extinguisher nozzle or sprinkler head replacement; medical drug delivery or mixing and other medical applications; agricultural purposes; painting applications; fire suppression systems within aircraft cabins and storage bays; food processing applications; any application where an efficient mixture is required of two or more substances, liquids or gases; fuel nozzles; fuel furnaces; power plant scrubbers; and eductors (for mixing of powders).

The converging-diverging nozzle 17 includes a nozzle intake section 19, a convergent mixing flow zone 21 adjacent to the nozzle intake section 19, a throat section 23 adjacent to the convergent mixing flow zone 21, a divergent mixing flow zone 25 adjacent to the throat section 23, and a nozzle exit section 27 adjacent to the divergent mixing flow zone 25. In the preferred embodiment, the converging-diverging nozzle 17 has an inner diameter that has a cross section that is substantially circular. This inner diameter extends through the length of the converging-diverging nozzle 17. As shown in FIG. 1, the nozzle intake section 19 has an inner diameter of X (which is substantially similar to the size/diameter of the nozzle port 15), the throat section 23 has an inner diameter of Y, and the nozzle exit section 27 has an inner diameter of Z. The throat section 23 has an inner diameter (Y) smaller than the inner diameter (X) of the nozzle intake section 19. As shown in FIG. 1, the nozzle intake section 19 and the nozzle exit section 27 are disposed on opposite ends of the converging-diverging nozzle 17.

In the preferred embodiment, the supply ports 11, 13 have a cross section that is substantially circular; however, they may have any type of cross section practicable. The first supply port 11 has a inner diameter of A, and the second supply port has a inner diameter of B.

Typically the diameter X of the nozzle intake section 19 is equal to the diameter Z of the nozzle exit section 27. However, in instances where several substances, liquids or gases are to be mixed through one fluids mixing nozzle 1, the diameter X of the nozzle intake section 19 and the nozzle port 15 is increased proportionately to the number of extra quantities of agents to accommodate the influx through the nozzle intake section 19 and into the convergent mixing flow zone 21. For maximum mixing and performance of the fluids mixing nozzle 1, the inside diameter Y of the throat section 23 is half that of the inside diameter Z of the nozzle exit section 27.

In preferred embodiments of the present invention, the following ratios of inner diameters of the first fluid supply port 11(A), the second fluid supply port 13(B), the nozzle intake section 19(X), the throat section 23(Y) and the nozzle exit section 27(Z), respectively, are as follows:

1. A=B=X=Z=2Y, for even preliminary fundamental mixing and even convergent mixing (preferred range, easiest to manufacture);

2. A=B=X=2Z=4Y or A=B=X=2Z=3Y, for even preliminary fundamental mixing and more convergent mixing;

3. A=B=2X=2Z=4Y, for enhanced preliminary fundamental mixing and even convergent mixing;

4. A=3B=3X=3Z=6Y or A=2B=2X=2Z=4Y, for uneven preliminary fundamental mixing and even convergent mixing;

5. A=3B=4X=5Z=6Y or A=2B=3X=4Z=5Y, for uneven preliminary fundamental mixing and uneven convergent mixing (most difficult to manufacture); and,

6. A=B=X=3Z=4Y or A=B=X=4Z=5Y, for even preliminary fundamental mixing and uneven convergent mixing.

In operation, fluids (or substances) enter the internal portion 7 of the mixing chamber 3 via the first supply port 11 and the second supply port 13. In another embodiment of the invention, there may be a plurality of supply ports in order to mix more than two fluids and/or substances. Fluids and/or substances of various types may enter the internal portion 7 of the mixing chamber 3 through the fluid supply ports, where they interact and mix. The supply ports may be in fluid communication with fluid holding tanks, which contain and/or store the respective fluids to be mixed. In a fire extinguishant environment, the fluid holding tanks may hold air and water, respectively. Another example of substances that can be used in the fluids mixing nozzle 1, but without limitation, is nitrogen (or an inert gas) with potassium powder or aerosol. Another example, particularly in a system with three fluid supply ports, could be water, a surfactant (to enhance water such as “FireBlock”) and an inert gas.

The preliminary mixture in the internal portion 7 of the mixing chamber 3 is mixed and reacts and then enters the converging-diverging nozzle 17 via the nozzle port 15. Upon entering the diverging-converging nozzle 17, the mixture enters the convergent mixing flow zone 21. The mixture is then choked and abruptly compressed as it flows through the throat section 23 and into the divergent mixing flow zone 25. The fully mixed resultant flow that exits through the nozzle exit section 27 is atomized into a fine mist, and can be used for desired result and intended applications.

If a gas is used as one of two constituents to be mixed the following process occurs: the gas and either a liquid or other substance (i.e. aerosol, powder, oil, kerosene, paint, medicine, pesticide, etc.) flow together into the internal portion 7 of the mixing chamber 3 and are preliminarily mixed. The gas and substance or liquid will encounter some additional preliminary mixing as they approach the throat section 23 of the converging-diverging nozzle 17. Then, the substance or liquid flows through the throat section 23 with the highly compressed gas. After passing through the throat section 23 of the diverging section of the converging-diverging nozzle 17 and into the divergent mixing flow zone 25, the gas rapidly expands with an increase in velocity. The energy from this rapid expansion of the gas shears the substance or liquid, causing it to shatter (explode) into droplets or particles. Effective atomization depends upon the viscosity of the substance or liquid to be mixed, and the ratio of gas to substance or liquid within the fluids mixing nozzle 1. This ratio can be varied by the operator or engineered into the system process to accommodate the desired result or intended application. This process usually occurs at low pressure (less than 50 psi), but higher pressures (greater than 50 psi) can be utilized if required for fine atomization of higher viscosity substances.

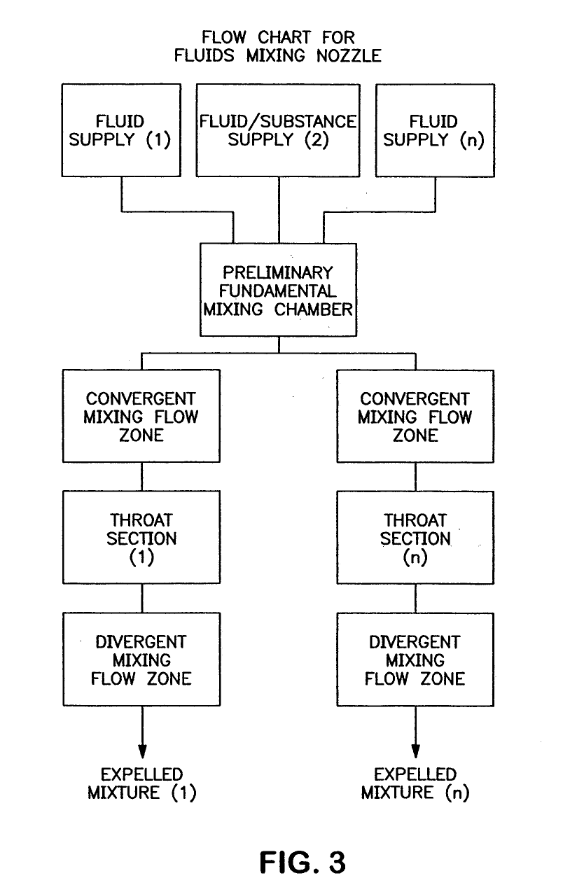

The fluids mixing nozzle 1 may also be utilized as a single stand-alone or part of a multiple nozzle array designed system. In an embodiment of the invention, there may be multiple diverging-converging nozzles 17. FIG. 3 shows a flow chart describing the process when using multiple diverging-converging nozzles 17, where n represents the number of diverging-converging nozzles 17 used. The fluids mixing nozzle 1 may be clamped, pressed, screwed or otherwise fastened into housings, chambers, tanks, hoses and the like.

Upon exiting the narrowed throat section 23, the flow rapidly expands into the divergent mixing flow zone 25, and then exits the converging-diverging nozzle 17 via the nozzle exit section 27. As discussed above, because of the compression and subsequent rapid expansion of the compressed flow (the mixed fluids/substances), the fluid(s) (and/or other substances) are sheared into small droplets or are atomized. The sequence discussed above is illustrated in FIG. 3.

The fluids mixing nozzle 1 allows mixing of two or more gases, fluids or substances to achieve a multi-phase mixture therethrough, thereby effectuating efficient use of fully mixed agents. Further, the fluids mixing nozzle 1 herein works efficiently enough to allow a generally larger than conventional-sized nozzle for mixing of two or more gases, fluids or substances or combination thereof to be used, which tends not to clog like the conventional nozzles.

Other industries may require a hardened fluids mixing nozzle for abrasive substances or liquids and chemical solutions mixing.

Alternatives in construction of the fluids mixing nozzle 1 can be utilized. The fluids mixing nozzle 1 works well at very low pressures, therefore the use of plastics for a molded single unitary assembly is possible, as well as multiple elements of the same or different materials being connected so as to form the fluids mixing nozzle 1. Other alternatives in construction are possible depending on the mixing that may occur. For example, but without limitation, in some mixing applications a polished stainless steel may be the best construction, such as in the food or medical industries.

When introducing elements of the present invention or the preferred embodiment(s) thereof, the articles “a”, “an”, “the,” and “said” are intended to mean there are one or more of the elements. The terms “comprising,” “including,” and “having” are intended to be inclusive and mean that there may be additional elements other than the listed elements.

Although the present invention has been described in considerable detail with reference to a certain preferred embodiment thereof, other embodiments are possible. Therefore, the spirit and scope of the appended claims should not be limited to the description of the preferred embodiment(s) contained herein.

What is claimed is:

1. A fluids mixing nozzle for mixing and atomization of substances, comprising:
a mixing chamber, the mixing chamber including a first side and a second side, the first side and the second side disposed on opposite sides of the mixing chamber;
a first fluid supply port, the first fluid supply port flowably communicating with the mixing chamber, the first fluid supply port disposed on the first side of the mixing chamber;
a second fluid supply port, the second fluid supply port flowably communicating with the mixing chamber, the second fluid supply port disposed on the first side of the mixing chamber;
a nozzle port, the nozzle port disposed on the second side of the mixing chamber; and,
a converging-diverging nozzle, the nozzle port allowing fluid communication between the mixing chamber and the converging-diverging nozzle, the converging-diverging nozzle including a nozzle intake section, a convergent mixing flow zone adjacent to the nozzle intake section, a throat section adjacent to the convergent mixing flow zone, the throat section having an inner diameter smaller than the inner diameter of the nozzle intake section, a divergent mixing flow zone adjacent to the throat section, and a nozzle exit section adjacent to the divergent mixing flow zone.

2. The fluids mixing nozzle of claim 1, wherein the fluids mixing nozzle comprises at least two converging-diverging nozzles.

3. A fluids mixing nozzle for mixing and atomization of substances, comprising:
a mixing chamber, the mixing chamber including a first side and a second side, the first side and the second side disposed on opposite sides of the mixing chamber;
a first fluid supply port, the first fluid supply port flowably communicating with the mixing chamber, the first fluid supply port disposed on the first side of the mixing chamber, the first fluid supply port having an inner diameter of A;
a second fluid supply port, the second fluid supply port flowably communicating with the mixing chamber, the second fluid supply port disposed on the first side of the mixing chamber, the second fluid supply port having an inner diameter of B;
a nozzle port, the nozzle port disposed on the second side of the mixing chamber; and,
a converging-diverging nozzle, the nozzle port allowing fluid communication between the mixing chamber and the converging-diverging nozzle, the converging-diverging nozzle including a nozzle intake section, the nozzle intake section having an inner diameter of X, a convergent mixing flow zone adjacent to the nozzle intake section, a throat section adjacent to the convergent mixing flow zone, the throat section having an inner diameter of Y and smaller than the inner diameter of the nozzle intake section, a divergent mixing flow zone adjacent to the throat section, and a nozzle exit section adjacent to the divergent mixing flow zone, the nozzle section having an inner diameter of Z.

4. The fluids mixing nozzle of claim 3, wherein A=B=X=Z=2Y.

5. The fluids mixing nozzle of claim 3, wherein A=B=X=2Z=4Y.

6. The fluids mixing nozzle of claim 3, wherein A=B=2X=2Z=4Y.

7. The fluids mixing nozzle of claim 3, wherein A=3B=3X=3Z=6Y.

8. The fluids mixing nozzle of claim 3, wherein A=3B=4X=5Z=6Y.

9. The fluids mixing nozzle of claim 3, wherein A=B=X=3Z=4Y.

10. The fluids mixing nozzle of claim 3, wherein A=B=X=2Z=3Y.

11. The fluids mixing nozzle of claim 3, wherein A=2B=2X=2Z=3Y.

12. The fluids mixing nozzle of claim 3, wherein A=2B=3X=4Z=5Y.

13. The fluids mixing nozzle of claim 3, wherein A=B=X=4Z=5Y.

14. The fluids mixing nozzle of claim 3, wherein the mixing nozzle comprises three or more fluid supply ports.

15. A fluids mixing nozzle for mixing and atomization of substances, comprising:
a mixing chamber, the mixing chamber including a first side and a second side, the first side and the second side disposed on opposite sides of the mixing chamber;
at least three fluid supply ports, the fluid supply ports flowably communicating with the mixing chamber, the fluid supply ports disposed on the first side of the mixing chamber;
a nozzle port, the nozzle port disposed on the second side of the mixing chamber; and,
a converging-diverging nozzle, the nozzle port allowing fluid communication between the mixing chamber and the converging-diverging nozzle, the converging-diverging nozzle including a nozzle intake section, a convergent mixing flow zone adjacent to the nozzle intake section, a throat section adjacent to the convergent mixing flow zone, the throat section having an inner diameter smaller than the inner diameter of the nozzle intake section, a divergent mixing flow zone adjacent to the throat section, and a nozzle exit section adjacent to the divergent mixing flow zone.
